(19) United States
(12) Patent Application Publication
(10) Pub. No.: US 2025/0166550 A1
(43) Pub. Date: May 22, 2025

(54) DISPLAY DEVICE AND METHOD OF DRIVING THE SAME

(71) Applicant: Samsung Display Co., Ltd., Yongin-Si (KR)

(72) Inventors: Jong Sik SHIM, Yongin-si (KR); Sang Myoung LEE, Yongin-si (KR); Dae Seop KIM, Yongin-si (KR); Tae Hoon KIM, Yongin-si (KR); Seung Hwan CHEONG, Yongin-si (KR); Seung Ji CHA, Yongin-si (KR)

(21) Appl. No.: 18/908,793

(22) Filed: Oct. 8, 2024

(30) Foreign Application Priority Data
Nov. 20, 2023 (KR) 10-2023-0161378

(51) Int. Cl. G09G 3/20; G09G 3/32; G09G 3/3233

(52) U.S. Cl. CPC G09G 3/2074; G09G 3/32; G09G 3/3233; G09G 2300/0819; G09G 2300/0852; G09G 2300/0861; G09G 2310/08; G09G 2320/0233; G09G 2320/045

(57) ABSTRACT

A display device includes a display panel including a sub-pixel, and a display panel driver for driving the display panel. The sub-pixel includes a driving transistor, a storage capacitor connected to a control electrode of the driving transistor, a write transistor writing a data voltage to the storage capacitor in response to a write gate signal, a first emission transistor providing a first power voltage to a first electrode of the driving transistor in response to a first emission signal, a hold capacitor including a first electrode receiving the first power voltage and a second electrode connected to a second electrode of the driving transistor, and a light emitting element emitting light. The first emission signal has an active level in a first portion of each of first periods of one frame, and has the active level in each of second periods respectively subsequent to the first periods.

### CROSS-REFERENCE TO RELATED APPLICATION

The present application claims priority under 35 U.S.C. § 119 (a) to Korean patent application No. 10-2023-0161378 filed on Nov. 20, 2023, in the Korean Intellectual Property Office, the entire disclosure of which is incorporated herein by reference.

### BACKGROUND

### 1. Technical Field

The present disclosure generally relates to a display device and a method of driving the same.

### 2. Related Art

With the development of information technologies, the importance of a display device which is a connection medium between a user and information increases. Accordingly, display devices such as a liquid crystal display device and an organic light emitting display device are increasingly used.

A display device may display an image, using a plurality of sub-pixels. Mura which is luminance non-uniformity of a display device may occur in the display device according to a structure and an operation of each pixel circuit of the sub-pixels.

### SUMMARY

Embodiments provide a display device for decreasing an off-time of a first emission signal.

Embodiments also provide a method of driving the display device.

In accordance with an aspect of the present disclosure, there is provided a display device including: a display panel including a sub-pixel; and a display panel driver configured to drive the display panel, wherein the sub-pixel includes: a driving transistor generating a driving current, the driving transistor including a control electrode, a first electrode and a second electrode; a storage capacitor connected between a control electrode of the driving transistor and the second electrode of the driving transistor; a write transistor connected between a data line and the control electrode of the driving transistor, the write transistor writing a data voltage to the storage capacitor in response to a write gate signal; a first emission transistor connected between a first power voltage line and the first electrode of the driving transistor, the first emission transistor providing a first power voltage to the first electrode of the driving transistor in response to a first emission signal; a hold capacitor connected between the first power voltage line and the second electrode of the driving transistor; and a light emitting element connected to the driving transistor, and wherein the first emission signal has an active level in a first portion of each of first periods of one frame and has the active level in each of second periods respectively subsequent to the first periods.

The first emission signal may be toggled between the active level and an inactive level in each of the first periods.

The first periods may include a first sub-period in which the data voltage is written to the sub-pixel and a second sub-period different from the first sub-period.

The sub-pixel may further include a first initialization transistor connected between a first initialization voltage line and the light emitting element, the first initialization transistor providing a first initialization voltage to the light emitting element in response to an initialization gate signal. The initialization gate signal may have an active level in a second portion of the second sub-period, in which the first emission signal has an inactive level.

The initialization gate signal may have an inactive level in the first portion of the second sub-period.

The initialization gate signal may have an active level in the first portion of the second sub-period.

Each of the first periods may include a first sub-period in which the data voltage is written to the sub-pixel and a second sub-period different from the first sub-period. The sub-pixel may further include a first initialization transistor connected between a first initialization voltage line and the light emitting element, the first initialization transistor providing a first initialization voltage to the light emitting element in response to an initialization gate signal. The initialization gate signal may have an active level in a second portion of at least one of the second sub-periods in which the first emission signal has an inactive level.

The first periods may include a first sub-period in which the data voltage is written to the sub-pixel and a second sub-period different from the first sub-period. The write gate signal may have an active level in at least a portion of the first sub-period, and have an inactive level in the second sub-period and the second periods.

The sub-pixel may further include a first initialization transistor connected between a first initialization voltage line and the light emitting element, the first initialization transistor providing a first initialization voltage to the light emitting element in response to an initialization gate signal. The initialization gate signal may have an active level in a period in which the write gate signal has the active level.

The sub-pixel may further include a reference transistor connected between a reference voltage line and the control electrode of the driving transistor, the reference transistor providing a reference voltage to the storage capacitor in response to a reference gate signal.

The first periods may include a first sub-period in which the data voltage is written to the sub-pixel and a second sub-period different from the first sub-period. The reference gate signal may have an active level in at least a portion of the first sub-period, and have an inactive level in the second sub-period and the second periods.

The sub-pixel may further include a first initialization transistor connected between a first initialization voltage line and the light emitting element, the first initialization transistor providing a first initialization voltage to the light emitting element in response to an initialization gate signal. The initialization gate signal may have an active level in a period in which the first emission signal and the reference gate signal have the active level.

The sub-pixel may further include a second emission transistor connected between the driving transistor and the light emitting element, the second emission transistor connecting the driving transistor to the light emitting element in response to a second emission signal.

The first periods may include a first sub-period in which the data voltage is written to the sub-pixel and a second sub-period different from the first sub-period. The second emission signal may have an active level in at least a portion of the first sub-period, and have an inactive level in the second sub-period and the second periods.

The sub-pixel may further include a second initialization transistor connected between a second initialization voltage line and the second electrode of the driving transistor, the second initialization transistor providing a second initialization voltage to the storage capacitor in response to an initialization gate signal.

In accordance with another aspect of the present disclosure, there is provided a method of driving a display device, the method including: writing a data voltage to a sub-pixel in a first sub-period; providing the sub-pixel with a first emission signal having an active level, thereby allowing a light emitting element of the sub-pixel to emit light in a second period subsequent to the first sub-period; providing the sub-pixel with the first emission signal toggled between the active level and an inactive level in a second sub-period subsequent to the second period; and providing the sub-pixel with the first emission signal having the active level, thereby allowing the light emitting element to emit light in a second period subsequent to the second sub-period.

The sub-pixel may include: a driving transistor generating a driving current; a storage capacitor connected to a control electrode of the driving transistor; a write transistor writing the data voltage to the storage capacitor in response to a write gate signal; a first emission transistor providing a first power voltage to a first electrode of the driving transistor in response to the first emission signal; and a hold capacitor including a first electrode receiving the first power voltage and a second electrode connected to a second electrode of the driving transistor. The light emitting element may emit light by receiving the driving current from the driving transistor.

The method may further include applying a first initialization voltage to the light emitting element in a portion of the second sub-period in which the first emission signal has an inactive level.

The method may further include applying a first initialization voltage to the light emitting element in a portion of the second sub-period in which the first emission signal has an active level.

When a data voltage is written to the sub-pixel, a first initialization voltage may be applied to the light emitting element.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present between the two elements. Like reference numerals refer to like elements throughout.

FIG. 1 is a block diagram illustrating a display device in accordance with embodiments of the present disclosure.

FIG. 2 is a circuit diagram illustrating an example of a sub-pixel of the display device shown in FIG. 1.

FIG. 3 is a timing diagram illustrating a comparative example in which the sub-pixel shown in FIG. 2 is driven.

FIG. 4 is a diagram illustrating mura in accordance with the comparative example shown in FIG. 3.

FIG. 5 is a timing diagram illustrating that a sub-pixel corresponding to a dark portion shown in FIG. 4 is driven.

FIG. 6 is a timing diagram illustrating that a sub-pixel corresponding to a light portion shown in FIG. 4 is driven.

FIG. 7 is a timing diagram illustrating an example in which the sub-pixel shown in FIG. 2 is driven.

FIG. 8 is a timing diagram illustrating in an example in which a display device drives a sub-pixel in accordance with embodiments of the present disclosure.

FIG. 9 is a circuit diagram illustrating an example of a sub-pixel of a display device in accordance with embodiments of the present disclosure.

FIG. 10 is a circuit diagram illustrating an example of a sub-pixel of a display device in accordance with embodiments of the present disclosure.

FIG. 11 is a flowchart illustrating a method of driving a display device in accordance with embodiments of the present disclosure.

FIG. 12 is a block diagram illustrating an electronic device in accordance with embodiments of the present disclosure.

FIG. 13 is a diagram illustrating an example in which the electronic device shown in FIG. 12 is implemented as a television.

### DETAILED DESCRIPTION

Hereinafter, embodiments of the present disclosure will be described in more detail with reference to the accompanying drawings. In the description below, only a necessary part to understand an operation according to the present disclosure is described and the descriptions of other parts are omitted in order not to unnecessarily obscure subject matters of the present disclosure. In addition, the present disclosure is not limited to exemplary embodiments described herein, but may be embodied in various different forms. Rather, exemplary embodiments described herein are provided to describe the disclosed contents thoroughly and completely and to sufficiently transfer the ideas of the disclosure to a person of ordinary skill in the art.

In the entire specification, when an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating a specific embodiment and not intended to limit the embodiment. It will be understood that when a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be limited by these terms. These terms are only used to distinguish one element from another element. Thus, a “first” element discussed below could also be termed a “second” element without departing from the teachings of the present disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

In addition, the embodiments of the disclosure are described here with reference to schematic diagrams of ideal embodiments (and an intermediate structure) of the present disclosure, so that changes in a shape as shown due to, for example, manufacturing technology and/or a tolerance may be expected. Therefore, the embodiments of the present disclosure shall not be limited to the specific shapes of a region shown here, but include shape deviations caused by, for example, the manufacturing technology. The regions shown in the drawings are schematic in nature, and the shapes thereof do not represent the actual shapes of the regions of the device, and do not limit the scope of the disclosure.

Hereinafter, exemplary embodiments of the present disclosure will be described in detail with reference to the accompanying drawings.

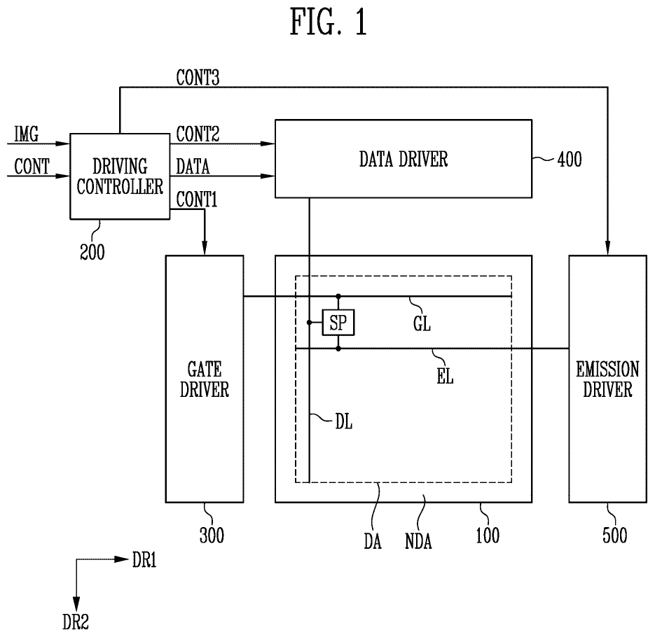

FIG. 1 is a block diagram illustrating a display device in accordance with embodiments of the present disclosure.

Referring to FIG. 1, the display device may include a display panel 100 and a display panel driver. The display panel driver may include a driving controller 200, a gate driver 300, a data driver 400, and an emission driver 500. In an embodiment, the driving controller 200 and the data driver 400 may be integrated into one chip.

The display panel 100 may include a display area DA in which an image is displayed and a non-display area NDA disposed adjacent to the display area DA. In an embodiment, the gate driver 300 and the emission driver 500 may be mounted in the non-display area NDA.

The display panel 100 may include a plurality of gate lines GL, a plurality of data lines DL, a plurality of emission lines EL, and a plurality of sub-pixels SP electrically connected to the gate lines GL, the data lines DL, and the emission lines EL. The gate lines GL and the emission lines EL may extend in a first direction DR1, and the data lines may extend in a second direction DR2 intersecting the first direction DR1.

The driving controller 200 may receive input image data IMG and an input control signal CONT from a main processor (e.g., a graphic processing unit (GPU) or the like). For example, the input image data IMG may include red image data, green image data, and blue image data. In an embodiment, the input image data IMG may further include white image data. In another example, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, and a data signal DATA based on the input image data IMG and the input control signal CONT.

The driving controller 200 may generate the first control signal CONT1 for controlling an operation of the gate driver 300 based on the input control signal CONT and output the first control signal CONT1 to the gate driver 300. The first control signal CONT1 may include a vertical start signal and a gate clock signal.

The driving controller 200 may generate the second control signal CONT2 for controlling an operation of the data driver 400 based on the input control signal CONT and output the second control signal CONT2 to the data driver 400. The second control signal CONT2 may include a horizontal start signal and a load signal.

The driving controller 200 may generate the data signal DATA using the input image data IMG and the input control signal CONT. The driving controller 200 may output the data signal DATA to the data driver 400.

The driving controller 200 may generate the third control signal CONT3 for controlling an operation of the emission driver 500 based on the input control signal CONT and output the third control signal CONT3 to the emission driver 500. The third control signal CONT3 may include a vertical start signal and an emission clock signal.

The gate driver 300 may generate gate signals for driving the gate lines GL in response to the first control signal CONT1 input from the driving controller 200. The gate driver 300 may output the gate signals to the gate lines GL. For example, the gate driver 300 may sequentially output the gate signals to the gate lines GL.

The data driver 400 may receive the second control signal CONT2 and the data signal DATA which are input from the driving controller 200. The data driver 400 may generate data voltages obtained by converting the data signal DATA into a voltage in an analog form. The data driver 400 may output the data voltages to the data lines DL.

The emission driver 500 may generate emission signals for driving the emission lines EL in response to the third control signal CONT3 input from the driving controller 200. The emission driver 500 may output the emission signals to the emission lines EL. For example, the emission driver 500 may sequentially output the emission signals to the emission line EL.

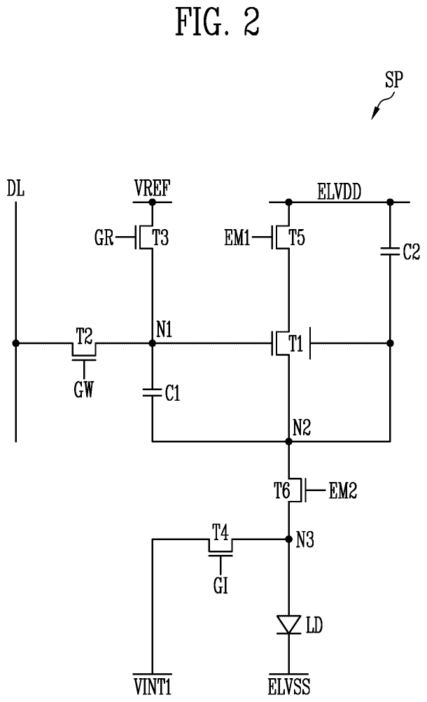

FIG. 2 is a circuit diagram illustrating an example of the sub-pixel of the display device shown in FIG. 1.

Referring to FIG. 2, the sub-pixel SP may include a driving transistor T1 generating a driving current, a storage capacitor C1 connected to a control electrode of the driving transistor T1, a write transistor T2 writing a data voltage to the storage capacitor C1 in response to a write gate signal GW, a first emission transistor T5 providing a first power voltage ELVDD to a first electrode of the driving transistor T1 in response to a first emission signal EM1, a hold capacitor C2 including a first electrode receiving the first power voltage ELVDD and a second electrode connected to a second electrode of the driving transistor T1, a light emitting element LD emitting light by receiving the driving current, a first initialization transistor T4 providing a first initialization voltage VINT1 to a anode of the light emitting element LD in response to the initialization gate signal GI, a reference transistor T3 providing a reference voltage VREF to the control electrode of the driving transistor in response to a reference gate signal GR, and a second emission transistor T6 connecting the driving transistor T1 to the light emitting element LD in response to a second emission signal EM2. This will be described in detail later.

The driving transistor T1 may include the control electrode connected to a first node N1, the first electrode connected to the first emission transistor T5, the second electrode connected to a second node N2, and a back-gate connected to the second node. The write transistor T2 may include a control electrode receiving the write gate signal GW, a first electrode connected to a data line DL, and a second electrode connected to the first node N1. The reference transistor T3 may include a gate electrode receiving the reference gate signal GR, a first electrode receiving the reference voltage VREF, and a second electrode connected to the first node N1. The first initialization transistor T4 may include a control electrode receiving the initialization gate signal GI, a first electrode receiving the first initialization voltage VINT1, and a second electrode connected to a third node N3. The first emission transistor T5 may include a control electrode receiving the first emission signal EM1, a first electrode receiving the first power voltage ELVDD (e.g., a high power voltage), and a second electrode connected to the first electrode of the driving transistor T1. The second emission transistor T6 may include a control electrode receiving the second emission signal EM2, a first electrode connected to the second node N2, and a second electrode connected to the third node N3. The storage capacitor C1 may include a first electrode connected to the first node N1 and a second electrode connected to the second node N2. The hold capacitor C2 may include the first electrode receiving the first power voltage ELVDD and the second electrode connected to the back-gate of the driving transistor T1 to the second node N2. For example, the light emitting element LD may include a first electrode connected to the third node N3 and a second electrode receiving a second power voltage ELVSS (e.g., a low power voltage). However, the present disclosure is not limited to the structure of the sub-pixel SP.

Hereinafter, it is assumed that the transistors T1, T2, T3, T4, T5, and T6 are implemented with an n-channel metal oxide semiconductor (NMOS) transistor. For example, each of the transistors T1, T2, T3, T4, T5, and T6 may be an N-type oxide thin film transistor. In another embodiment, the transistors T1, T2, T3, T4, T5, and T6 may be implemented with a p-channel metal oxide semiconductor (PMOS) transistor. For example, each of the transistors T1, T2, T3, T4, T5, and T6 may be a P-type silicon thin film transistor. In another embodiment, some of the transistors T1, T2, T3, T4, T5, and T6 may be implemented with the NMOS transistor, and the others of the transistors T1, T2, T3, T4, T5, and T6 may be implemented with the PMOS transistor.

An oxide thin film transistor may be a Low Temperature Polycrystalline Oxide (LTPO) thin film transistor in which an active pattern (semiconductor layer) includes oxide. However, this is merely illustrative, and N-type transistors are not limited thereto. For example, the active pattern (semiconductor layer) included in the N-type transistor may include an inorganic semiconductor (e.g., amorphous silicon, poly-silicon), an organic semiconductor, or the like. A silicon thin film transistor may be a Low Temperature Poly-silicon (LTPS) in which an active pattern (semiconductor layer) includes amorphous silicon, poly-silicon, and the like.

In the case of the NMOS transistor, a low voltage level may be an inactive level, and the high voltage level may be an active level. For example, when a signal applied to a control electrode of the NMOS transistor has the low voltage level, the NMOS transistor may be turned off. For example, when the signal applied to the control electrode of the NMOS transistor has the high voltage level, the NMOS transistor may be turned on.

In the case of the PMOS transistor, a low voltage level may be the active level, and the high voltage level may be the inactive level. For example, when a signal applied to a control electrode of the PMOS transistor has the low voltage level, the PMOS transistor may be turned on. For example, when the signal applied to the control electrode of the PMOS transistor has the high voltage level, the PMOS transistor may be turned off. That is, the active level and the non-active level may be determined according to kinds of transistors.

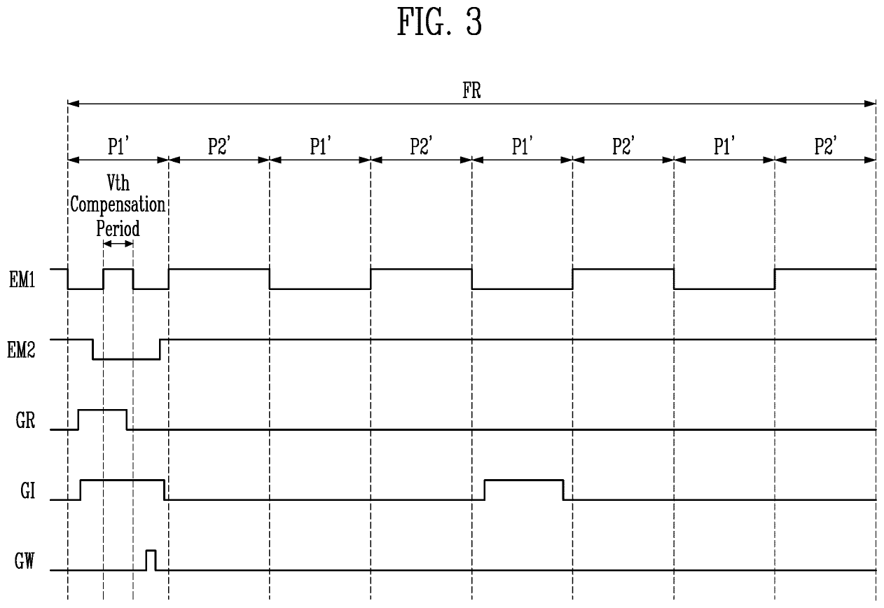

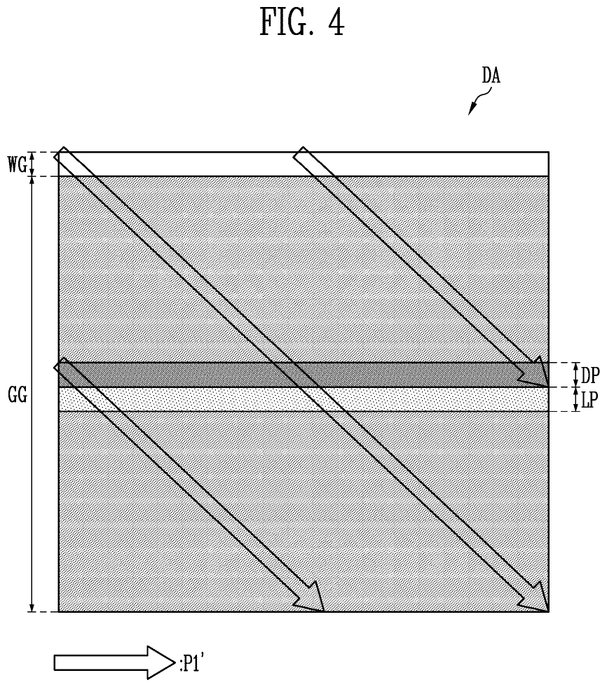

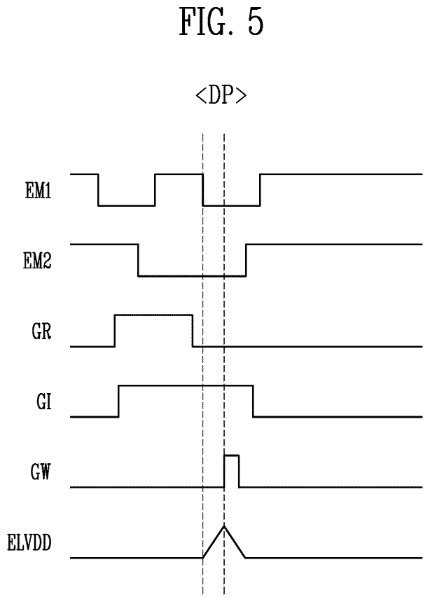

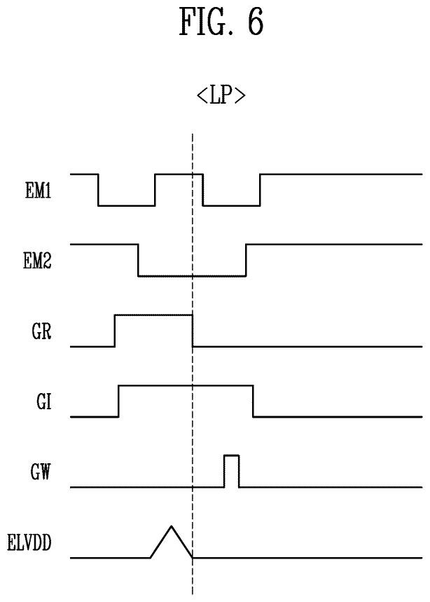

FIG. 3 is a timing diagram illustrating a comparative example in which the sub-pixel shown in FIG. 2 is driven. FIG. 4 is a diagram illustrating mura in accordance with the comparative example shown in FIG. 3. FIG. 5 is a timing diagram illustrating that a sub-pixel corresponding to a dark portion shown in FIG. 4 is driven. FIG. 6 is a timing diagram illustrating that a sub-pixel corresponding to a light portion shown in FIG. 4 is driven.

FIGS. 3 to 6 are diagrams illustrating mura caused by a voltage drop (e.g., IR Drop) of the first power voltage ELVDD, and contents described with reference to FIGS. 3 to 6 are related to the comparative example.

Referring to FIGS. 2 and 3, first periods P1′ and second periods P2′ may be alternatingly repeated in one frame FR. The first periods P1′ may be periods in which the light emitting element LD does not emit light, and the second periods P2′ may be periods in which the light emitting element LD emits light.

The first emission signal EM1 may have the inactive level except a period for compensating for a threshold voltage of the driving transistor T1 in the first period P1′. The first emission signal EM1 may have the active level throughout the second period P2′.

That is, the driving current may flow through the light emitting element LD in the second period P2′, and may not flow through the light emitting element LD in the first period P1′.

FIG. 4 illustrates that a white grayscale WG (e.g., grayscale 255) is displayed in a top portion of the display area DA and a gray grayscale GG (e.g., grayscale 127) is displayed in the other portion of the display area DA.

Referring to FIGS. 2 to 4, an area (i.e., a dark portion DP) in which a grayscale darker than the gray grayscale GG is displayed and an area (i.e., a light portion LP) in which a grayscale lighter than the gray grayscale GG is displayed may occur in the display area DA. Hereinafter, this will be described in detail.

When a current flows in the line to which the first power voltage ELVDD is provided, a voltage drop of the first power voltage ELVDD may occur. In particular, since a high driving current flows in the sub-pixel SP displaying the white grayscale WG, a difference in voltage drop between when the driving current flows in the sub-pixel SP displaying the white grayscale WG and when the driving current does not flow in the sub-pixel SP displaying the white grayscale WG may be large. Accordingly, when the driving current does not instantaneously flow in the sub-pixel SP displaying the white grayscale WG, the first power voltage ELVDD may increase. That is, the first power voltage ELVDD in the first period P1′ with respect to the sub-pixel SP displaying the white grayscale WG may increase. In addition, when the driving current again flows in the sub-pixel SP displaying the white grayscale WG, the first power voltage ELVDD may decrease.

Referring to FIGS. 2, 4, and 5, the dark portion DP may occur when the first power voltage ELVDD increases in a period before the first emission transistor T5 is turned off and the write transistor T2 is turned on in one frame. Due to the hold capacitor C2, a voltage of the second electrode of the driving transistor T1 may increase, and a gate-source voltage of the driving transistor T1 may decrease. Accordingly, the driving current may decrease. That is, a grayscale lower than the gray grayscale GG may be displayed at the dark portion DP.

Referring to FIGS. 2, 4, and 6, the light portion LP may occur when the first power voltage ELVDD decreases in a period before the reference transistor T3 is turned on and then turned off in one frame. Due to the hold capacitor C2, the voltage of the second electrode of the driving transistor T1 may decrease, and the gate-source voltage of the driving transistor T1 may increase. Accordingly, the driving current may increase. That is, a grayscale higher than the gray grayscale GG may be displayed at the light portion LP.

As such, as the voltage drop of the first power voltage ELVDD becomes larger, mura may be more clearly viewed. In addition, the mura caused by the voltage drop of the first power voltage ELVDD may become larger as a period (i.e., an off-period) in which the first emission signal EM1 has the inactive level becomes longer. Therefore, in order to reduce the mura, it is necessary to decrease an off-time of the first emission signal EM1.

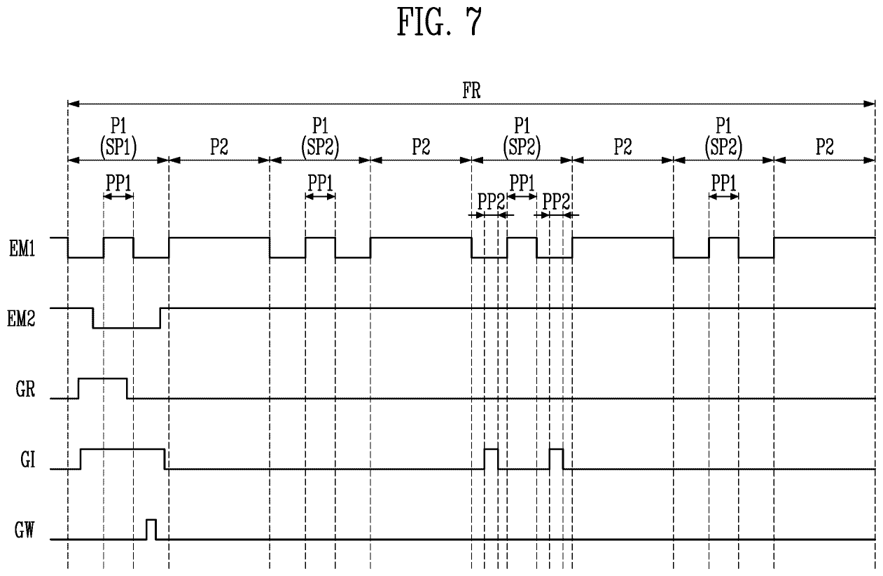

FIG. 7 is a timing diagram illustrating an example in which the sub-pixel shown in FIG. 2 is driven.

Referring to FIGS. 2 and 7, first periods P1 and second periods P2 may be alternatingly repeated in one frame FR. In this embodiment, it is illustrated that the first periods P1 and the second periods P2 are repeated four times. However, the present disclosure is not limited thereto.

The first periods P1 may include a first sub-period SP1 in which a data voltage is written to the sub-pixel SP and a second sub-period SP2 different from the first sub-period SP1.

Hereinafter, an operation in the first sub-period SP1 will be described.

First, the first emission signal EM1 having the inactive level may be applied to the sub-pixel SP. Accordingly, the first emission transistor T5 may be turned off, and an emission period based on a data voltage written in a previous frame may be ended.

Next, as the initialization gate signal GI having the active level is applied to the sub-pixel SP, the first initialization transistor T4 may be turned on. Accordingly, the light emitting element LD may be initialized. Since the second emission transistor T6 is in a turn-on state, the first initialization voltage VINT1 may be applied to the second node N2. Therefore, the hold capacitor C2 may be initialized.

In addition, as the reference gate signal GR having the active level is applied to the sub-pixel SP, the reference transistor T3 may be turned on. Accordingly, the reference voltage VREF may be applied to the first node N1. Therefore, the storage capacitor C1 may be initialized.

Next, as the first emission signal EM1 having the active level is applied to the sub-pixel SP, the first emission transistor T5 may be turned on. While the reference gate signal GR has the active level, a voltage of the first electrode of the storage capacitor C1 may increase to correspond to the threshold voltage of the driving transistor T1. Since a current flows through the first emission transistor T5 and the driving transistor T1, a voltage of the second node N2 may gradually increase. When the gate-source voltage of the first transistor T1 reaches the threshold voltage of the driving transistor T1, the driving transistor T1 may be turned off, and the voltage of the second node N2 may be maintained. Accordingly, the storage capacitor C1 may store a voltage corresponding to the threshold voltage of the driving transistor T1.

The initialization gate signal GI may have the active level in a period in which the first emission signal EM1 and the reference gate signal GR have the active level. Accordingly, while the threshold voltage of the first transistor T1 is compensated, the first electrode (e.g., an anode electrode) of the light emitting element LD may be maintained at the first initialization voltage VINT1.

Next, as the write gate signal GW having the active level is applied to the sub-pixel SP, the write transistor T2 may be turned on. A data voltage may be written to the storage capacitor C1 in a state in which the data voltage is applied to the data line DL. The voltage of the second node N2 may vary according to a capacitance ratio of the capacitors C1 and C2 and the threshold voltage of the driving transistor T1.

The initialization gate signal GI may have the active level in a period in which the write gate signal GW has the active level. Accordingly, while the data voltage is written, the first electrode (e.g., the anode electrode) of the light emitting element LD may be maintained at the first initialization voltage VINT1.

Next, in a second period P2 subsequent to the first sub-period SP1, as the first and second emission signals EM1 and EM2 having the active level are applied to the sub-pixel SP, the first and second emission transistors T5 and T6 may be turned on. Accordingly, the first power voltage ELVDD may be applied to the first electrode of the driving transistor T1, and the driving transistor T1 may be connected to the light emitting element LD. Also, the driving transistor T1 may generate a driving current corresponding to the written data voltage, and the light emitting element LD may emit light by receiving the driving current.

In the second period P2 and the second sub-period SP2, the second emission signal EM2 may have the active level, and the reference gate signal GR and the write gate signal GW may have the inactive level.

The first emission signal EM1 may be toggled between the active level and the inactive level in each of the first periods P1. For example, the first emission signal EM1 may include two inactive periods and one active period in each of the first periods P1. The inactive period is a period in which the first emission signal EM1 has the inactive level, and the active period is a period in which the first emission signal EM1 has the active level.

The first emission signal EM1 may have the active level in a first portion PP1 of the second sub-period SP2. Accordingly, the off-time of the first emission signal EM1 may decrease. As described above, as the off-time of the first emission signal EM1 decrease, the mura caused by the voltage drop of the first power voltage ELVDD can be reduced.

The initialization gate signal GI may have the active level in a second portion PP2 of at least one of second sub-periods SP2 in which the first emission signal EM1 has the inactive level. Accordingly, the light emitting element LD may be initialized between second period P2 in which the light emitting element LD emits light.

In an embodiment, the initialization gate signal GI may have the inactive level in the first portion PP1 of the second sub-period SP2. Accordingly, the driving current may flow through the light emitting element LD in the first portion PP1.

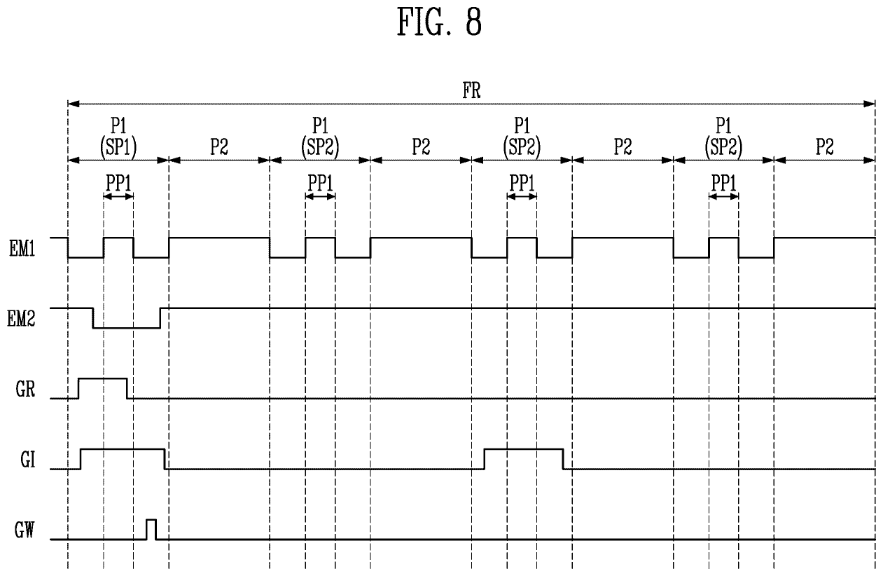

FIG. 8 is a timing diagram illustrating in an example in which a display device drives a sub-pixel in accordance with embodiments of the present disclosure.

The display device in accordance with these embodiments is substantially identical to the display device shown in FIG. 1 except the initialization gate signal GI in a first portion PP1, and therefore, components identical or similar to those of the display device shown in FIG. 1 are designated by like reference numerals, and overlapping descriptions will be omitted.

Referring to FIGS. 2 and 8, the initialization gate signal GI may have the active level in the first portion PP1 of the second sub-period SP2. Accordingly, a certain current may flow through the light emitting element LD.

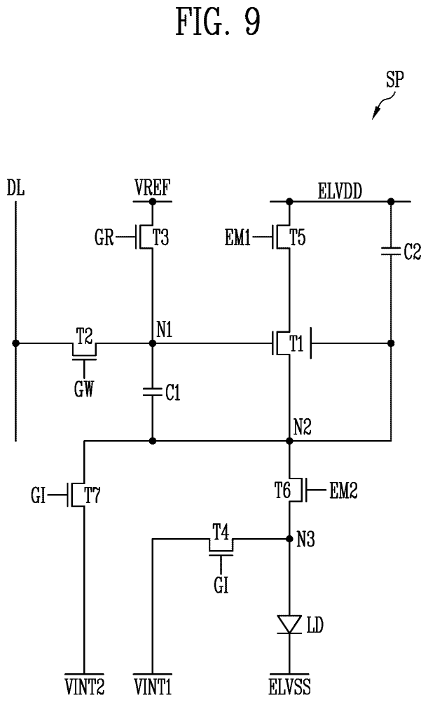

FIG. 9 is a circuit diagram illustrating an example of a sub-pixel of a display device in accordance with embodiments of the present disclosure.

The display device in accordance with these embodiments is substantially identical to the display device shown in FIG. 1 except a second initialization transistor T7, and therefore, components identical or similar to those of the display device shown in FIG. 1 are designated by like reference numerals, and overlapping descriptions will be omitted.

Referring to FIG. 9, the sub-pixel SP may further include the second initialization transistor T7 providing a second initialization voltage VINT2 to the storage capacitor C1 in response to the initialization gate signal GI.

For example, the second initialization transistor T7 may include a control electrode receiving the initialization gate signal GI, a first electrode receiving the second initialization voltage VINT2, and a second electrode connected to the second node N2.

For example, as the initialization gate signal GI having the active level is applied to the sub-pixel SP, the second initialization transistor T7 may be turned on. Accordingly, the second initialization voltage VINT2 may be applied to the second node N2. Therefore, the storage capacitor C1 and the hold capacitor C2 may be initialized.

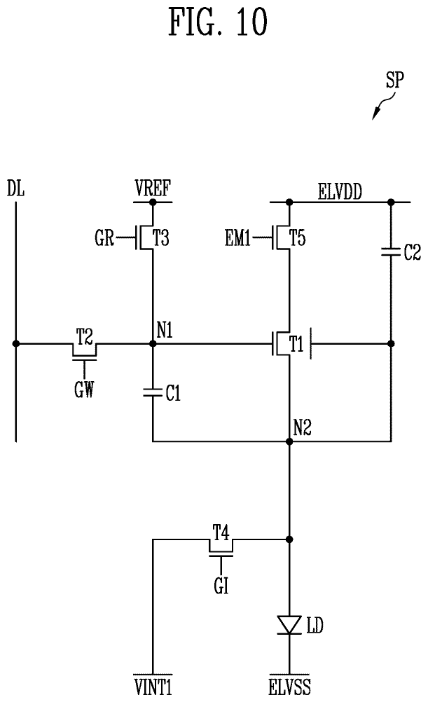

FIG. 10 is a circuit diagram illustrating an example of a sub-pixel of a display device in accordance with embodiments of the present disclosure.

The display device in accordance with these embodiments is substantially identical to the display device shown in FIG. 1 except that the display device in accordance with these embodiments does not include the second emission transistor T6, and therefore, components identical or similar to those of the display device shown in FIG. 1 are designated by like reference numerals, and overlapping descriptions will be omitted.

Referring to FIG. 10, the second electrode of the first initialization transistor T4 may be directly connected to the second node N2, and the first electrode of the light emitting element LD may be directly connected to the second node N2.

For example, as the initialization gate signal GI having the active level is applied to the sub-pixel SP, the first initialization transistor T4 may be turned on. Accordingly, the first initialization voltage VINT1 may be applied to the second node N2. Therefore, the light emitting element LD, the storage capacitor C1, and the hole capacitor C2 may be initialized.

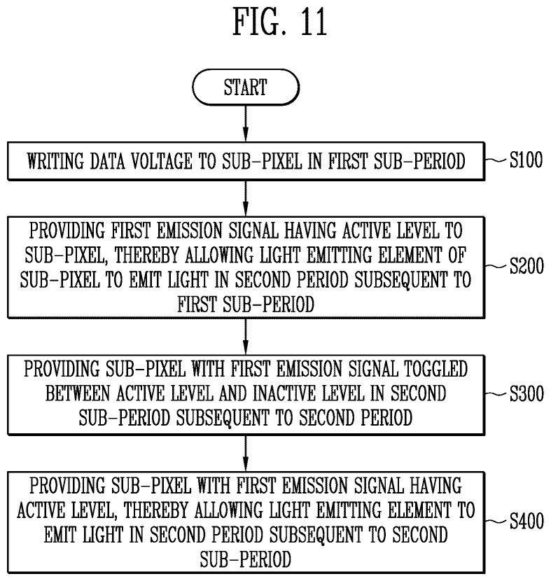

FIG. 11 is a flowchart illustrating a method of driving a display device in accordance with embodiments of the present disclosure.

Referring to FIG. 11, in the method of driving the display device, a data voltage may be written to a sub-pixel in a first sub-period (S100), a first emission signal having an active level may be provided to the sub-pixel, thereby allowing a light emitting element of the sub-pixel to emit light in a second period subsequent to the first sub-period (S200), the first emission signal toggled between the active level and an inactive level may be provided to the sub-pixel in a second sub-period subsequent to the second period (S300), and a first emission signal having the active level may be provided to the sub-pixel, thereby allowing the light emitting element to emit light in a second period subsequent to the second sub-period (S400).

The method of driving the display device, which is shown in FIG. 11, may be performed on any one of the sub-pixels described with reference to FIGS. 2 and 7 to 10. Therefore, overlapping descriptions will be omitted.

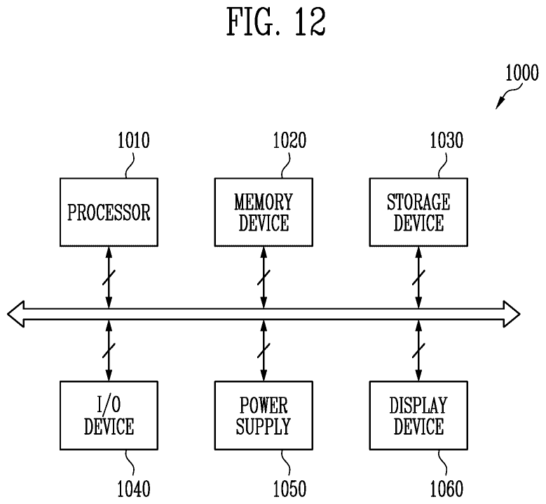

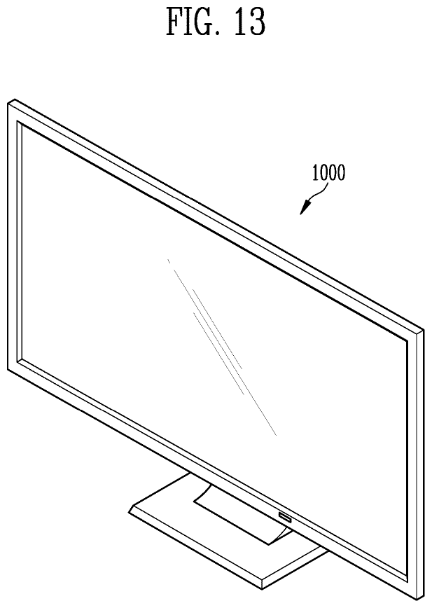

FIG. 12 is a block diagram illustrating an electronic device in accordance with embodiments of the present disclosure. FIG. 13 is a diagram illustrating an example in which the electronic device shown in FIG. 12 is implemented as a television.

Referring to FIGS. 12 and 13, the electronic device 1000 may include a processor 1010, a memory device 1020, a storage device 1030, an input/output (I/O) device 1040, a power supply, 1050, and a display device 1060. The display device 1060 may be the display device shown in FIG. 1. Also, the electronic device 1000 may further include several ports capable of communicating with a video card, a sound card, a memory card, a USB device, and the like, or communicating with other systems. In an embodiment, as shown in FIG. 13, the electronic device 1000 may be implemented as a television. However, this is merely illustrative, and the electronic device 1000 is not limited thereto. For example, the electronic device 1000 may be implemented as a mobile phone, a video phone, a smart pad, a smart watch, a tablet PC, a vehicle navigation system, a computer monitor, a notebook computer, a head mounted display device, or the like.

The processor 1010 may perform specific calculations or tasks. In some embodiments, the processor 1010 may be a microprocessor, a central processing unit, an application processor, or the like. The processor 1010 may be connected to other components through an address bus, a control bus, a data bus, and the like. In some embodiments, the processor 1010 may be connected to an extension bus such as a peripheral component interconnect (PCI) bus.

The memory device 1020 may store data necessary for an operation of the electronic device 1000. For example, the memory device 1010 may include a nonvolatile memory device such as an Erasable Programmable Read-Only Memory (EPROM) device, an Electrically Erasable Programmable Read-Only Memory (EEPROM) device, a flash memory device, a Phase Change Random Access Memory (PRAM) device, a Resistance Random Access Memory (RRAM) device, a Nano Floating Gate Memory (NFGM) device, a Polymer Random Access Memory (PoRAM) device, a Magnetic Random Access Memory (MRAM) device, or a Ferroelectric Random Access Memory (FRAM) device, and/or a volatile memory device such as a Dynamic Random Access Memory (DRAM) device, a Static Random Access Memory (SRAM) device, or a mobile DRAM device.

The storage device 1030 may include a Solid State Drive (SSD), a Hard Disk Drive (HDD), a CD-ROM, and the like.

The I/O device 1040 may include an input means such as a keyboard, a keypad, a touch screen, or a mouse, and an output means such as a speaker or a printer. In some embodiments, the display device 1060 may be included in the I/O device 1040.

The power supply 1050 may supply power necessary for an operation of the electronic device 1000. For example, the power supply 1050 may be a power management integrated circuit (PMIC).

The display device 1060 may display an image corresponding to visual information of the electronic device 1000. The display device 1060 may be an organic light emitting display device or a quantum dot light emitting display device, but the present disclosure is not limited thereto. The display device 1060 may be connected to other components through the buses or another communication link.

The present disclosure can be applied to display devices and electronic devices including the same. For example, the present disclosure can be applied to digital TVs, 3D TVs, mobile phones, smart phones, tablet computers, VR devices, PCs, home appliances, notebook computers, PDAs, PMPs, digital cameras, music players, portable game consoles, navigation systems, and the like.

In the display device in accordance with the present disclosure, an off-time of the first emission signal is decreased, so that mura caused by a voltage drop (e.g., an IR Drop) of the first power voltage can be minimized.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A display device comprising:
a display panel including a sub-pixel; and
a display panel driver configured to drive the display panel,
wherein the sub-pixel includes:
a driving transistor generating a driving current, the driving transistor including a control electrode, a first electrode and a second electrode;
a storage capacitor connected between a control electrode of the driving transistor and the second electrode of the driving transistor;
a write transistor connected between a data line and the control electrode of the driving transistor, the write transistor writing a data voltage to the storage capacitor in response to a write gate signal;
a first emission transistor connected between a first power voltage line and the first electrode of the driving transistor, the first emission transistor providing a first power voltage to the first electrode of the driving transistor in response to a first emission signal;
a hold capacitor connected between the first power voltage line and the second electrode of the driving transistor; and
a light emitting element connected to the driving transistor, and
wherein the first emission signal has an active level in a first portion of each of first periods of one frame and has the active level in each of second periods respectively subsequent to the first periods.

2. The display device of claim 1, wherein the first emission signal is toggled between the active level and an inactive level in each of the first periods.

3. The display device of claim 1, wherein the first periods include a first sub-period in which the data voltage is written to the sub-pixel and a second sub-period different from the first sub-period.

4. The display device of claim 3, wherein the sub-pixel further includes a first initialization transistor connected between a first initialization voltage line and the light emitting element, the first initialization transistor providing a first initialization voltage to the light emitting element in response to an initialization gate signal, and
wherein the initialization gate signal has an active level in a second portion of the second sub-period, in which the first emission signal has an inactive level.

5. The display device of claim 4, wherein the initialization gate signal has an inactive level in the first portion of the second sub-period.

6. The display device of claim 4, wherein the initialization gate signal has an active level in the first portion of the second sub-period.

7. The display device of claim 1, wherein each of the first periods include a first sub-period in which the data voltage is written to the sub-pixel and a second sub-period different from the first sub-period,
wherein the sub-pixel further includes a first initialization transistor connected between a first initialization voltage line and the light emitting element, the first initialization transistor providing a first initialization voltage to the light emitting element in response to an initialization gate signal, and
wherein the initialization gate signal has an active level in a second portion of at least one of the second sub-periods in which the first emission signal has an inactive level.

8. The display device of claim 1, wherein the first periods include a first sub-period in which the data voltage is written to the sub-pixel and a second sub-period different from the first sub-period, and
wherein the write gate signal has an active level in at least a portion of the first sub-period, and has an inactive level in the second sub-period and the second periods.

9. The display device of claim 8, wherein the sub-pixel further includes a first initialization transistor connected between a first initialization voltage line and the light emitting element, the first initialization transistor providing a first initialization voltage to the light emitting element in response to an initialization gate signal, and
wherein the initialization gate signal has an active level in a period in which the write gate signal has the active level.

10. The display device of claim 1, wherein the sub-pixel further includes a reference transistor connected between a reference voltage line and the control electrode of the driving transistor, the reference transistor providing a reference voltage to the storage capacitor in response to a reference gate signal.

11. The display device of claim 10, wherein the first periods include a first sub-period in which the data voltage is written to the sub-pixel and a second sub-period different from the first sub-period, and
wherein the reference gate signal has an active level in at least a portion of the first sub-period, and has an inactive level in the second sub-period and the second periods.

12. The display device of claim 11, wherein the sub-pixel further includes a first initialization transistor connected between a first initialization voltage line and the light emitting element, the first initialization transistor providing a first initialization voltage to the light emitting element in response to an initialization gate signal, and
wherein the initialization gate signal has an active level in a period in which the first emission signal and the reference gate signal have the active level.

13. The display device of claim 1, wherein the sub-pixel further includes a second emission transistor connected between the driving transistor and the light emitting element, the second emission transistor connecting the driving transistor to the light emitting element in response to a second emission signal.

14. The display device of claim 13, wherein the first periods include a first sub-period in which the data voltage is written to the sub-pixel and a second sub-period different from the first sub-period, and
wherein the second emission signal has an active level in at least a portion of the first sub-period, and has an inactive level in the second sub-period and the second periods.

15. The display device of claim 1, wherein the sub-pixel further includes a second initialization transistor connected between a second initialization voltage line and the second electrode of the driving transistor, the second initialization transistor providing a second initialization voltage to the storage capacitor in response to an initialization gate signal.

16. A method of driving a display device, the method comprising:
writing a data voltage to a sub-pixel in a first sub-period;
providing the sub-pixel with a first emission signal having an active level, thereby allowing a light emitting element of the sub-pixel to emit light in a second period subsequent to the first sub-period;
providing the sub-pixel with the first emission signal toggled between the active level and an inactive level in a second sub-period subsequent to the second period; and
providing the sub-pixel with the first emission signal having the active level, thereby allowing the light emitting element to emit light in a second period subsequent to the second sub-period.

17. The method of claim 16, wherein the sub-pixel includes:
a driving transistor generating a driving current;
a storage capacitor connected to a control electrode of the driving transistor;
a write transistor writing the data voltage to the storage capacitor in response to a write gate signal;
a first emission transistor providing a first power voltage to a first electrode of the driving transistor in response to the first emission signal; and
a hold capacitor including a first electrode receiving the first power voltage and a second electrode connected to a second electrode of the driving transistor, and
wherein the light emitting element emits light by receiving the driving current from the driving transistor.

18. The method of claim 16, further comprising applying a first initialization voltage to the light emitting element in a portion of the second sub-period in which the first emission signal has an inactive level.

19. The method of claim 18, further comprising applying a first initialization voltage to the light emitting element in a portion of the second sub-period in which the first emission signal has an active level.

20. The method of claim 16, wherein, when a data voltage is written to the sub-pixel, a first initialization voltage is applied to the light emitting element.
